(19) United States
(12) Patent Application Publication
(10) Pub. No.: US 2023/0344007 A1
(43) Pub. Date: Oct. 26, 2023

(54) LITHIUM SECONDARY BATTERY

(71) Applicant: TeraWatt Technology K.K., Yokohama-shi (JP)

(72) Inventors: Juichi Arai, Yokohama-shi (JP); Ken Ogata, Yokohama-shi (JP)

(73) Assignee: TeraWatt Technology K.K., Yokohama-shi (JP)

(21) Appl. No.: 18/342,205

(22) Filed: Jun. 27, 2023

Related U.S. Application Data
(63) Continuation of application No. PCT/JP2020/049055, filed on Dec. 28, 2020.

(51) Int. Cl. H01M 10/0567; H01M 10/0569; H01M 10/052

(52) U.S. Cl. CPC H01M 10/0567; H01M 10/0569; H01M 10/052; H01M 2300/0037; H01M 2300/0034

(57) ABSTRACT

The purpose of the present invention is to provide a lithium secondary battery having a high energy density and an excellent cycle characteristic. The present invention relates to a lithium secondary battery having a positive electrode and a negative electrode not having a negative electrode active material, wherein the lithium secondary battery contains a compound having a 1,3,5-triazine ring skeleton.

### CROSS REFERENCE TO RELATED APPLICATION

This application is a continuation of International Application No. PCT/JP2020/049055, filed on Dec. 28, 2020, the entire contents of which are incorporated by reference.

### TECHNICAL FIELD

The present invention relates to a lithium secondary battery.

### BACKGROUND ART

The technology of converting natural energy such as solar light and wind power into electric energy has recently attracted attentions. Under such a situation, various secondary batteries have been developed as a highly-safe power storage device capable of storing a lot of electric energy.

Among them, lithium secondary batteries which charge/discharge by transferring lithium ions between a positive electrode and a negative electrode are known to exhibit a high voltage and high energy density. As the typical lithium secondary battery, a lithium ion secondary battery which contains an active material capable of retaining a lithium element in the positive electrode and the negative electrode, and which charges/discharges by delivering or receiving lithium ions between the positive electrode active material and the negative electrode active material is known.

In addition, for the purpose of realizing high energy density, there has been developed a lithium secondary battery that lithium metal is used as the negative electrode active material, instead of a material into which the lithium element can be inserted, such as a carbon-based material. For example, Patent Document 1 discloses a lithium secondary battery including an ultrathin lithium-metal anode, in which a volume energy density exceeding 1000 Wh/L, and/or a mass energy density exceeding 350 Wh/kg is realized at the time of discharge at at least a rate of 1 C at room temperature. Patent Document 1 discloses that, in such a lithium secondary battery, charge is performed by a direct precipitation of a new lithium metal on the lithium metal as the negative electrode active material.

For the purpose of further improving high energy density and improving productivity, or the like, a lithium secondary battery which does not use a negative electrode active material has been developed. For example, Patent Document 2 discloses a lithium secondary battery including a positive electrode and a negative electrode, and a separation membrane and an electrolyte interposed therebetween. In the aforesaid negative electrode, metal particles formed on a negative electrode current collector are transferred from the positive electrode when the battery is charged and a lithium metal is formed on the negative electrode current collector in the negative electrode. Patent Document 2 discloses that such a lithium secondary battery shows the possibility of providing a lithium secondary battery which has overcome the problem due to the reactivity of the lithium metal and the problem caused during assembly and therefore has improved performance and service life.
Patent Document 1: Published Japanese Translation of PCT application No 2019-517722
Patent Document 2: Published Japanese Translation of PCT application No 2019-505971

### BRIEF SUMMARY OF THE INVENTION

### Technical Problem

As a result of detailed investigation of conventional batteries including those described in the Patent Documents, the present inventors have found that at least either one of their energy density and cycle characteristic is not sufficient.

For example, in the lithium secondary battery which includes a negative electrode having the negative electrode active material, due to the occupation volume or mass of the negative electrode active material, it is difficult to sufficiently increase the energy density and a capacity. In addition, even in a conventional anode free lithium secondary battery, which includes a negative electrode not having a negative electrode active material, due to repeated charging/discharging, a dendritic lithium metal is likely to be formed on a surface of the negative electrode, which is likely to cause a short circuit and a decrease in capacity, resulting in insufficient cycle characteristic.

In the anode free lithium secondary battery, a method of applying a large physical pressure on a battery to keep the interface between a negative electrode and a separator at high pressure has also been developed in order to suppress the discrete growth at the time of lithium metal deposition. Application of such a high pressure however needs a large mechanical mechanism, leading to an increase in the weight and volume of the battery and a reduction in energy density as the entire battery.

The present invention has been made in consideration of the aforesaid problems and a purpose is to provide a lithium secondary battery having a high energy density and excellent in cycle characteristic.

### Solution to Problem

A lithium secondary battery according to an aspect of the present invention has a positive electrode and a negative electrode not having a negative electrode active material, wherein the lithium secondary battery contains a compound having a 1,3,5-triazine ring skeleton.

Because such a lithium secondary battery does not have a negative electrode active material, the volume and mass of the entire battery are reduced as compared with a lithium secondary battery having a negative electrode active material, and the energy density is high in principle. In such a battery, charge/discharge are performed by depositing lithium metal on the surface of the negative electrode and electrolytically dissolving the deposited lithium.

The present inventors have found that, in the compound having a 1,3,5-triazine ring skeleton, nitrogen atoms constituting the triazine ring, and hydrogen atoms or atoms constituting a substituent, which are bonded at a 2-position, a 4-position, or a 6-position, interact with the lithium ion, resulting in stabilization of the lithium ion, and have found that an anode free lithium secondary battery containing such a compound having a 1,3,5-triazine ring skeleton is excellent in cycle characteristic. In the anode free lithium secondary battery, the factors that the cycle characteristic is improved by containing the compound having a 1,3,5-triazine ring skeleton are not necessarily clear, but the present inventors have presumed that, because the aforesaid compound stabilizes the lithium ion in the battery, a reaction rate of lithium-metal deposition reaction on the surface of the negative electrode is appropriately controlled, and non-uniform deposition reaction of the lithium metal, that is, growth reaction of dendritic lithium metal is suppressed.

It is preferable that the aforesaid compound is a compound in which at least one thiol group is bonded to the 1,3,5-triazine ring skeleton. In such an aspect, because the compound having a 1,3,5-triazine ring skeleton interacts more preferably with the metal constituting the negative electrode, the growth reaction of the dendritic lithium metal is further suppressed, and the cycle characteristic of the battery tends to be further improved. From a similar standpoint, it is preferable that the aforesaid compound is a compound in which at least two thiol groups are bonded to the 1,3,5-triazine ring skeleton.

It is preferable that the aforesaid compound is a compound that has a 1,3,5-triazine ring skeleton having substituents at all of a 2-position, a 4-position, and a 6-position, in which the substituents are selected from the group consisting of a monovalent hydrocarbon group which may be substituted with a halogen atom, a hydroxy group, an alkoxy group, a thiol group, and an amino group which may be substituted with an unsubstituted hydrocarbon group. In such a mode, the cycle characteristic of the battery tends to be further improved.

It is preferable that the aforesaid lithium secondary battery further has a separator or a solid electrolyte which is placed between the aforesaid positive electrode and the aforesaid negative electrode. In such an aspect, the positive electrode can be separated from the negative electrode more reliably and a short circuit of the battery can be reliably suppressed further.

It is preferable that at least a part of the aforesaid compound is applied onto at least a part of a surface of the aforesaid negative electrode facing the aforesaid positive electrode. In such an aspect, when the lithium ion is reduced on the surface of the negative electrode, because the lithium ion is more reliably stabilized by the aforesaid compound present on the surface of the negative electrode, the growth reaction of the dendritic lithium metal is further suppressed, and the cycle characteristic of the battery tends to be further improved.

It is preferable that the aforesaid lithium secondary battery further has an electrolyte solution containing the aforesaid compound. In such an aspect, because the lithium ion is more reliably stabilized by the aforesaid compound in the battery, the growth reaction of the dendritic lithium metal is further suppressed, and the cycle characteristic of the battery tends to be further improved.

It is preferable that the aforesaid lithium secondary battery further has an electrolyte solution containing, as a solvent, a compound having at least one of a monovalent group represented by Formula (A) or a monovalent group represented by Formula (B). Here, in the formulae, a wavy line represents a bonding site in the monovalent group.

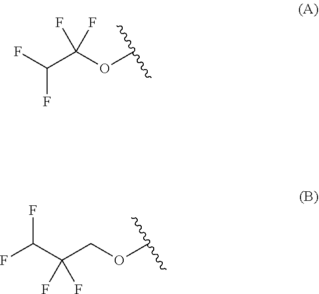 [SMILES: *OC(F)(F)C(F)F ; *OCC(F)(F)C(F)F]

In such an aspect, because a formation of a solid electrolyte interfacial layer (SEI layer) is promoted on the surface of the negative electrode, the cycle characteristic of the battery is further improved. Because the SEI layer has ionic conductivity, reactivity of lithium-metal deposition reaction on the surface of the negative electrode, on which the SEI layer is formed, is uniform in a planar direction of the surface of the negative electrode, and thus the growth of dendritic lithium metal on the negative electrode is suppressed.

In the aforesaid lithium secondary battery, charging and discharging are performed by depositing lithium metal on the surface of the negative electrode and electrolytically dissolving the deposited lithium.

The aforesaid negative electrode is preferably an electrode consisting of at least one selected from the group consisting of Cu, Ni, Ti, Fe, and other metals that do not react with Li, alloys of these metals, and stainless steel (SUS). In such an aspect, it has more excellent safety and excellent productivity because it does not need a lithium metal having high flammability for the manufacturing. In addition, such a negative electrode is stable and therefore, a secondary battery obtained using it has an improved cycle characteristic.

In the lithium secondary battery having the negative electrode not having a negative electrode active material, the negative electrode does not have a lithium metal on a surface of the negative electrode before initial charge and/or at an end of discharge. Therefore, the aforesaid lithium secondary battery has excellent safety and productivity because it does not need a lithium metal having high flammability for the manufacturing.

It is preferable that the aforesaid lithium secondary battery has an energy density of 350 Wh/kg or more.

The present invention makes it possible to provide a lithium secondary battery having a high energy density and an excellent cycle characteristic.

### BRIEF DESCRIPTION OF DRAWINGS

FIG. 1 is a schematic cross-sectional view of a lithium secondary battery according to First Embodiment.

FIG. 2 is a schematic cross-sectional view of the use of the lithium secondary battery according to First Embodiment.

FIG. 3 is a schematic cross-sectional view of a lithium secondary battery according to Second Embodiment.

### DETAILED DESCRIPTION

The embodiment of the present invention (which will hereinafter be called “present embodiment”) will hereinafter be described in detail while referring to the drawings as needed. In the drawings, the same element will be represented by the same reference numeral and an overlapping description will be omitted. Unless otherwise specifically described, the positional relationship such as vertical or horizontal one will be based on the positional relationship shown in the drawings. Further, a dimensional ratio in the drawings is not limited to the ratio shown in the drawings.

### First Embodiment

### Lithium Secondary Battery

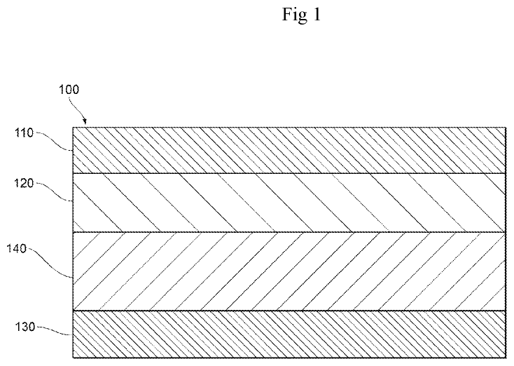

FIG. 1 is a schematic cross-sectional view of a lithium secondary battery of First Embodiment. The lithium secondary battery 100 in First Embodiment has a positive electrode 120 and a negative electrode 130 not having a negative electrode active material. In addition, in the lithium secondary battery 100, a positive electrode current collector 110 is placed on a side of the positive electrode 120, opposite to a surface facing the negative electrode 130, and a separator 140 is placed between the positive electrode 120 and the negative electrode 130.

The lithium secondary battery 100 further contains a compound having a 1,3,5-triazine ring skeleton (which will hereinafter also be called “triazine compound”), which is not shown in FIG. 1. It is sufficient that the triazine compound is contained in any one or more of components of the lithium secondary battery 100. Therefore, for example, the triazine compound may be applied onto at least a part of the surface of the positive electrode current collector 110 facing the negative electrode 130, may be contained in the positive electrode 120, may be applied onto at least a part of the surface of the negative electrode 130 facing the positive electrode 120, or may be contained in the surface of the separator 140 or inside the separator 140. The surface of the separator 140 may be a surface on the negative electrode 130 or a surface on the positive electrode 120 side. In a case where the lithium secondary battery 100 has an electrolyte solution, the triazine compound may be contained in the electrolyte solution.

Hereinafter, each configuration of the lithium secondary battery 100 will be described.

### Negative Electrode

The negative electrode 130 does not have a negative electrode active material, that is, does not have a lithium metal and an active material which serves as a host for lithium (lithium metal or ion). Therefore, in the lithium secondary battery 100, the volume and mass of the entire battery are reduced as compared with a lithium secondary battery having a negative electrode having a negative electrode active material, and the energy density is high in principle. In the aforesaid lithium secondary battery 100, charging and discharging are performed by depositing lithium metal on the surface of the negative electrode 130 and electrolytically dissolving the deposited lithium.

The term “lithium metal deposited on the negative electrode” as used herein means the lithium metal deposits on at least one of the surface of the negative electrode, which is coated with the triazine compound, the surface of the negative electrode, which is not coated with the triazine compound, or a surface of a solid electrolyte interfacial layer (SEI layer) formed on the surface of the negative electrode, which will be described later. Therefore, in the lithium secondary battery 100, for example, the lithium metal may deposit on the surface of the negative electrode 130, which is coated with the triazine compound (interface between the negative electrode 130 and the separator 140), or the surface of the negative electrode 130, which is not coated with the triazine compound.

The term “negative electrode active material” as used herein means a material for retaining, on the negative electrode 130, a lithium ion or a lithium metal, and it may be replaced by the term “a host material for a lithium element (typically, lithium ion)”. Such a retaining mechanism is not particularly limited and examples thereof include intercalation, alloying, and occlusion of metal clusters. Intercalation is typically used.

Such a negative electrode active material is not particularly limited and examples thereof include lithium metal, alloys with lithium metal, carbon-based materials, metal oxides, metals which can be alloyed with lithium, and alloys with the metals. The carbon-based material is not particularly limited and examples thereof include graphene, graphite, hard carbon, mesoporous carbon, carbon nanotube, and carbon nanohorn. The metal oxide is not particularly limited and examples thereof include titanium oxide-based compounds, tin oxide-based compounds, and cobalt oxide-based compounds. Examples of metals which can be alloyed with lithium include silicon, germanium, tin, lead, aluminum, and gallium.

The term negative electrode “does not have a negative electrode active material” as used herein means that the content of a negative electrode active material in the negative electrode is 10 mass % or less based on the total amount of the negative electrode. The content of a negative electrode active material in the negative electrode is preferably 5.0 mass % or less and it may be 1.0 mass % or less, 0.1 mass % or less, or 0.0 mass % or less, each based on the total amount of the negative electrode. Since the negative electrode does not have the negative electrode active material or the content of the negative electrode active material in the negative electrode is within the aforesaid range, the energy density of the lithium secondary battery 100 is high.

More specifically, in the negative electrode 130, regardless of the state of charge of the battery, the content of the negative electrode active material other than lithium metal is 10 mass % or less in the entire negative electrode, preferably 5.0 mass % or less, and may be 1.0 mass % or less, 0.1 mass % or less, or 0.0 mass % or less. In addition, in the negative electrode 130, before initial charge and/or at the end of discharge, the content of lithium metal is 10 mass % or less based on the entire negative electrode, preferably 5.0 mass % or less, and may be 1.0 mass % or less, 0.1 mass % or less, or 0.0 mass % or less.

In the negative electrode 130, before initial charge and at the end of discharge, the content of the lithium metal may be 10 mass % or less based on the entire negative electrode (preferably 5.0 mass % or less, and may be 1.0 mass % or less, 0.1 mass % or less, or 0.0 mass % or less); before initial charge or at the end of discharge, the content of the lithium metal may be 10 mass % or less based on the entire negative electrode (preferably 5.0 mass % or less, and may be 1.0 mass % or less, 0.1 mass % or less, or 0.0 mass % or less); before initial charge, the content of the lithium metal may be 10 mass % or less based on the entire negative electrode (preferably 5.0 mass % or less, and may be 1.0 mass % or less, 0.1 mass % or less, or 0.0 mass % or less); or at the end of discharge, the content of the lithium metal may be 10 mass % or less based on the entire negative electrode (preferably 5.0 mass % or less, and may be 1.0 mass % or less, 0.1 mass % or less, or 0.0 mass % or less).

Accordingly, the term “lithium secondary battery having a negative electrode not having a negative electrode active material” can be replaced by the term an anode-free secondary battery, a zero-anode secondary battery, or an anode-less secondary battery. In addition, the term “lithium secondary battery having a negative electrode not having a negative electrode active material” may be replaced by the term “lithium secondary battery having a negative electrode which does not have a negative electrode active material other than lithium metal and does not have a lithium metal before initial charge and/or at the end of discharge”, “lithium secondary battery having a negative electrode current collector which does not have a lithium metal before initial charge and/or at the end of discharge”, or the like. Here, the term “before initial charge and/or at the end of discharge” may be replaced with the term “before initial charge” or “at the end of discharge”.

The term “before initial charge” of the battery as used herein means a state from the time when the battery is assembled to the time when the battery is first charged. In addition, “at the end of discharge” of the battery means a state in which the battery voltage is 1.0 V or more and 3.8 V or less.

In the lithium secondary battery 100, in a case where the battery voltage is 1.0 V or more and 3.5 V or less, the content of the lithium metal may be 10 mass % or less based on the entire negative electrode (preferably 5.0 mass % or less, and may be 1.0 mass % or less, 0.1 mass % or less, or 0.0 mass % or less); in a case where the battery voltage is 1.0 V or more and 3.0 V or less, the content of the lithium metal may be 10 mass % or less based on the entire negative electrode (preferably 5.0 mass % or less, and may be 1.0 mass % or less, 0.1 mass % or less, or 0.0 mass % or less); or in a case where the battery voltage is 1.0 V or more and 2.5 V or less, the content of the lithium metal may be 10 mass % or less based on the entire negative electrode (preferably 5.0 mass % or less, and may be 1.0 mass % or less, 0.1 mass % or less, or 0.0 mass % or less).

In the lithium secondary battery 100, a ratio M_{3.0}/M_{4.2} of a mass M_{3.0} of lithium metal deposited on the negative electrode 130 in a state in which the battery voltage is 3.0 V to a mass M_{4.2} of lithium metal deposited on the negative electrode 130 in a state in which the battery voltage is 4.2 V is preferably 20% or less, more preferably 15% or less, and still more preferably 10% or less. The ratio M_{3.0}/M_{4.2} may be 8.0% or less, 5.0% or less, 3.0% or less, or 1.0% or less.

In a typical lithium secondary battery, the capacity of the negative electrode (capacity of the negative electrode active material) is set to be approximately the same as the capacity of the positive electrode (capacity of the positive electrode active material). However, in the lithium secondary battery 100, since the negative electrode 130 does not have a negative electrode active material which is a host material for a lithium element, it is not necessary to specify its capacity. Therefore, since the lithium secondary battery 100 is not limited by the charge capacity due to the negative electrode, the energy density can be increased in principle.

The negative electrode 130 is not particularly limited insofar as it does not have a negative electrode active material and is usable as a current collector. Examples thereof include electrodes consisting of at least one selected from the group consisting of Cu, Ni, Ti, Fe, and other metals that do not react with Li, alloys thereof, and stainless steels (SUS). When a SUS is used as the negative electrode 130, a variety of conventionally known SUSs can be used as its kind. One or more of the aforesaid negative electrode materials may be used either singly or in combination. The term “metal that does not react with Li” as used herein means a metal which does not form an alloy under the operation conditions of the lithium secondary battery, reacting with a lithium ion or a lithium metal.

The negative electrode 130 preferably consists of at least one selected from the group consisting of Cu, Ni, Ti, Fe, alloys thereof, and stainless steels (SUS), and more preferably consists of at least one selected from the group consisting of Cu, Ni, alloys thereof, and stainless steels (SUS). The negative electrode 130 still more preferably consists of Cu, Ni, alloys thereof, or stainless steels (SUS). When such a negative electrode is used, the energy density and productivity of the battery tend to be further improved.

The negative electrode 130 is an electrode not having a lithium metal. Therefore, it can be manufactured without using a highly flammable and highly reactive lithium metal so that the resulting lithium secondary battery 100 has excellent safety, productivity, and cycle characteristic.

The average thickness of the negative electrode 130 is preferably 4 μm or more and 20 μm or less, more preferably 5 μm or more and 18 μm or less, and still more preferably 6 μm or more and 15 μm or less. In such a mode, since the occupation volume of the negative electrode 130 in the lithium secondary battery 100 decreases, the lithium secondary battery 100 has a more improved energy density.

It is preferable that at least a part of the surface of the negative electrode 130 facing the positive electrode 120 is coated with the triazine compound so that a proportion of the triazine compound to be applied is within a range described later. In such a mode, the cycle characteristic of the battery tends to be further improved.

### Triazine Compound

Because the lithium secondary battery 100 has the negative electrode 130 not having a negative electrode active material, the energy density is high. However, the present inventors have found that there are problems that the short circuit of the battery occurs because, in a case of simply using the negative electrode not having a negative electrode active material, the dendritic lithium metal deposits on the negative electrode as the battery is charged/discharged, and that the capacity of the battery is lowered because, in a case where the deposited dendritic lithium metal is dissolved, a base portion of the dendritic lithium metal is eluted and some of the lithium metal peels off from the negative electrode and becomes inactive. As a result of intensive research, it has been found that, by containing the compound having a 1,3,5-triazine ring skeleton in the anode free lithium secondary battery, the lithium metal deposited on the negative electrode is suppressed from growing into a dendritic form, whereby the aforesaid problems can be overcome.

The present inventors have investigated a stable structure in a case where 1,3,5-triazine and lithium ion approach each other, by using molecular orbital calculation. As a result, it has been found that, in a case where the nitrogen atoms of 1,3,5-triazine and the hydrogen atoms bonded at the 2-position, the 4-position, or the 6-position interact with the lithium ion, the lithium ion is strongly stabilized. Therefore, the present inventors have presumed that the compound having a 1,3,5-triazine ring skeleton in the anode free lithium secondary battery improves the cycle characteristic of the battery due to the following factors. However, the suppressive factors are not limited to the following.

That is, in a case where the lithium secondary battery 100 contains the triazine compound, as described above, the nitrogen atoms constituting the triazine ring, and the hydrogen atoms or the atoms constituting a substituent, which are bonded at the 2-position, the 4-position, or the 6-position, interact with the lithium ion, resulting in stabilization of the lithium ion in the battery. When the lithium ion is stabilized, the lithium ion is easily transported inside the battery, and thus the internal resistance of the battery is reduced. Furthermore, when the lithium ion is reduced to the lithium metal on the surface of the negative electrode and when the lithium metal is oxidatively eluted with the lithium ion, by stabilizing the lithium ion, it is presumed that reaction rates of the deposition reaction of the lithium metal and the electrolytical dissolution reaction of the lithium metal are controlled, and local deposition and dissolution are less likely to occur. As a result, it is presumed that the non-uniform deposition reaction of the lithium metal, that is, the growth reaction of dendritic lithium metal is suppressed, and thus the cycle characteristic of the battery is improved.

Accordingly, it is sufficient that the triazine compound is contained in any one or more of components of the lithium secondary battery 100. For example, the triazine compound may be applied onto at least a part of the surface of the positive electrode current collector 110 facing the negative electrode 130, may be contained inside the positive electrode 120, may be applied onto at least a part of the surface of the positive electrode 120 facing the negative electrode 130, may be applied onto at least a part of the surface of the negative electrode 130 facing the positive electrode 120, or may be contained in the surface of the separator 140 or inside the separator 140. The surface of the separator 140, which contains the triazine compound, may be a surface on the negative electrode 130 or a surface on the positive electrode 120 side. In a case where the lithium secondary battery 100 has electrolyte solution, the triazine compound may be contained in the electrolyte solution.

In a case where the triazine compound is applied onto at least a part of the surface of the negative electrode 130 facing the positive electrode 120, it is presumed that reaction involving the lithium ion on the surface of the negative electrode (oxidation reaction and reduction reaction of lithium) can be effectively controlled, and such a mode is preferable. In the mode in which the triazine compound is applied onto at least a part of the surface of the negative electrode 130 facing the positive electrode 120, from the standpoint of strengthening the interaction between the triazine compound and the metal constituting the negative electrode, the triazine compound preferably has at least one thiol group, and more preferably has at least two thiol groups.

In addition, in a case where the triazine compound is contained in the electrolyte solution, because the lithium ion is effectively stabilized inside the battery, such an aspect is also preferable.

That is, the aspect in which the triazine compound is applied onto at least a part of the surface of the negative electrode 130 facing the positive electrode 120 or the aspect in which the triazine compound is contained in the electrolyte solution is more preferable.

The triazine compound has a 1,3,5-triazine ring skeleton. Specifically, the triazine compound is represented by Formula (1). Here, R is a hydrogen atom or any monovalent substituent. The triazine compound may be a polymer in which a plurality of 1,3,5-triazine ring skeletons is bonded through R. The number of polymerizations may be 10 or more, 50 or more, or 100 or more.

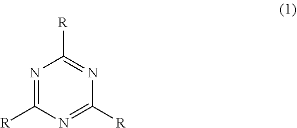

R in Formula (1) is not particularly limited and examples thereof include a hydrogen atom, a monovalent hydrocarbon group which may be substituted, a hydroxy group (—OH), an alkoxy group (—OR′), a thiol group (—SH), —SR′, an amino group which may be substituted with an unsubstituted hydrocarbon group (—NH₂₋ₙR′ₙ; n is an integer of 0 or more and 2 or less), and —OC(═O)—R′. Here, R′ means a monovalent unsubstituted hydrocarbon group. Examples of “hydrocarbon group” in the monovalent hydrocarbon group which may be substituted, in the hydrocarbon group which can substitute the amino group, and in the hydrocarbon group of R′ include groups obtained by removing one hydrogen atom from a saturated or unsaturated branched or linear aliphatic hydrocarbon or aromatic hydrocarbon. The number of carbon atoms in the aforesaid group may be 1 to 100, 1 to 50, or 1 to 10. In a case where the hydrocarbon group may be substituted, in the hydrocarbon group, some or all of the hydrogen atoms in the hydrocarbon group may be substituted with fluorine atoms.

R in Formula (1) is preferably selected from the group consisting of a hydrogen atom, a monovalent hydrocarbon group which may be substituted with a halogen atom, a hydroxy group, an alkoxy group, a thiol group, and an amino group which may be substituted with an unsubstituted hydrocarbon group; and more preferably selected from the group consisting of a hydrogen atom, a monovalent aliphatic hydrocarbon group having 1 to 3 carbon atoms (which is saturated or unsaturated, and is branched or linear), which may be substituted with a halogen atom, an alkoxy group having 1 to 3 carbon atoms (that is, a methoxy group, an ethoxy group, or a propoxy group), a thiol group, and an amino group which may be substituted with an unsubstituted aliphatic hydrocarbon group having 1 to 5 carbon atoms (which is saturated or unsaturated, and is branched or linear).

The halogen atom in the monovalent hydrocarbon group which may be substituted with a halogen atom is not particularly limited and may be a fluorine atom, a chlorine atom, a bromine atom, or an iodine atom, and a fluorine atom is preferable. In the amino group which may be substituted with an unsubstituted hydrocarbon group, the amino group may not be substituted, may be substituted with one hydrocarbon group, or may be substituted with two hydrocarbon groups. The hydrocarbon group which can substitute the amino group is preferably an unsubstituted aliphatic hydrocarbon group having 1 to 5 carbon atoms (which is saturated or unsaturated, and is branched or linear), more preferably an unsubstituted saturated or unsaturated linear aliphatic hydrocarbon group having 2 to 5 carbon atoms, and still more preferably a butyl group and/or an allyl group (—CH₂CH═CH₂).

The triazine compound is preferably a compound in which all R's in Formula (1) are not hydrogen atoms, that is, a compound in which all of the 2-position, the 4-position, and the 6-position of the triazine ring in Formula (1) are substituted with the substituents. Among them, the triazine compound is more preferably a compound in which R in Formula (1) is selected from the group consisting of a monovalent hydrocarbon group which may be substituted with a halogen atom, a hydroxy group, an alkoxy group, a thiol group, and an amino group which may be substituted with an unsubstituted hydrocarbon group; and still more preferably a compound in which R in Formula (1) is selected from the group consisting of a monovalent aliphatic hydrocarbon group having 1 to 3 carbon atoms (which is saturated or unsaturated, and is branched or linear), which may be substituted with a halogen atom, an alkoxy group having 1 to 3 carbon atoms (that is, a methoxy group, an ethoxy group, or a propoxy group), a thiol group, and an amino group which may be substituted with an unsubstituted aliphatic hydrocarbon group having 1 to 5 carbon atoms (which is saturated or unsaturated, and is branched or linear).

In Formula (1), it is preferable that at least one of the three R's is a thiol group, and it is more preferable that at least two thereof are thiol groups. In other words, the triazine compound is preferably a compound in which at least one thiol group is bonded to the 1,3,5-triazine ring skeleton, and more preferably a compound in which at least two thiol groups are bonded to the 1,3,5-triazine ring skeleton. In such a mode, because the thiol group and the metal constituting the negative electrode interact with each other more preferably, the triazine compound is easily retained on the surface of the negative electrode, and the growth reaction of the dendritic lithium metal tends to be further suppressed.

Examples of the triazine compound include a compound represented by Formula (I), (II), (III), (IV), or (V) (which will hereinafter be abbreviated as “(I) to (V)”.

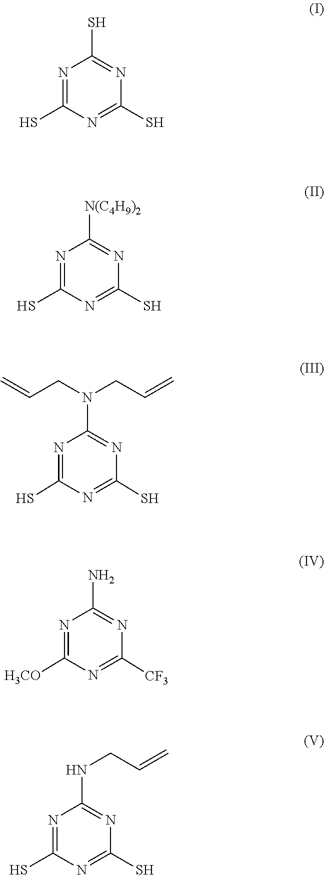

In a case where the triazine compound is contained in the electrolyte solution, among them, the triazine compound is preferably the compounds represented by Formulae (I) to (IV). One or more of the triazine compounds described above may be used either singly or in combination.

The content of the triazine compound is not particularly limited, and based on the mass of the entire battery, it may be 0.001 mass % or more, 0.005 mass % or more, 0.01 mass % or more, 0.05 mass % or more, 0.1 mass % or more, 0.5 mass % or more, 1.0 mass % or more, or 5.0 mass % or more. In addition, the content of the triazine compound may be 20 mass % or less, 15 mass % or less, or 10 mass % or less based on the mass of the entire battery. Alternatively, the content of the triazine compound may be 5 mass % or less or 1 mass % or less based on the mass of the entire battery. The content of the triazine compound may be within a range in which an arbitrary lower limit value and an arbitrary upper limit value, which are described above, are appropriately combined.

When the content of the triazine compound is equal to or more than the aforesaid lower limit value, the effect of stabilizing the lithium ion in the battery by the triazine compound tends to be effectively and reliably exerted.

The triazine compound may be applied onto at least a part of the surface of the negative electrode 130 facing the positive electrode 120. The triazine compound “is applied onto” at least a part of the surface of the negative electrode means a surface having an area ratio of 10% or more in the surface of the negative electrode has the triazine compound. In a case where the negative electrode 130 is coated with the triazine compound, the surface of the negative electrode is coated with the triazine compound in an area ratio of preferably 20% or more, 30% or more, 40% or more, or 50% or more, more preferably 70% or more, and still more preferably 80% or more.

The triazine compound may be applied onto at least a part of the surface of the positive electrode current collector 110 facing the negative electrode 130. The triazine compound “is applied to” at least a part of the surface of the positive electrode current collector means a surface having an area ratio of 10% or more in the surface of the positive electrode current collector has the triazine compound. In a case where the positive electrode current collector 110 is coated with the triazine compound, the surface of the positive electrode current collector is coated with the triazine compound in an area ratio of preferably 20% or more, 30% or more, 40% or more, or 50% or more, more preferably 70% or more, and still more preferably 80% or more.

The triazine compound may be contained inside the positive electrode 120. In a case where the triazine compound is contained inside the positive electrode 120, the content of the triazine compound in the positive electrode is preferably 0.01 mass % or more, more preferably 0.03 mass % or more, and still more preferably 0.05 mass % or more based on the mass of the positive electrode. The content of the triazine compound in the positive electrode is preferably 5.0 mass % or less, more preferably 3.0 mass % or less, still more preferably 1.0 mass % or less, and even more preferably 0.5 mass % or less based on the mass of the positive electrode. The content of the triazine compound in the positive electrode may be within a range in which an arbitrary lower limit value and an arbitrary upper limit value, which are described above, are appropriately combined.

The triazine compound may be applied to at least a part of the surface of the positive electrode 120 facing the negative electrode 130. The triazine compound “is applied onto” at least a part of the surface of the positive electrode means a surface having an area ratio of 10% or more in the surface of the positive electrode has the triazine compound. In a case where the positive electrode 120 is coated with the triazine compound, the surface of the positive electrode is coated with the triazine compound in an area ratio of preferably 20% or more, 30% or more, 40% or more, or 50% or more, more preferably 70% or more, and still more preferably 80% or more.

The triazine compound may be contained on the surface of the separator 140 and/or inside the separator 140. The content of the triazine compound in the separator is preferably 0.01 mass % or more, more preferably 0.03 mass % or more, and still more preferably 0.05 mass % or more based on the mass of the separator. The content of the triazine compound in the separator is preferably 5.0 mass % or less, more preferably 3.0 mass % or less, still more preferably 1.0 mass % or less, and even more preferably 0.5 mass % or less based on the mass of the separator. The content of the triazine compound in the separator may be within a range in which an arbitrary lower limit value and an arbitrary upper limit value, which are described above, are appropriately combined.

In a case where the lithium secondary battery 100 has an electrolyte solution, the triazine compound may be contained in the electrolyte solution. The content of the triazine compound in the electrolyte solution is preferably 0.01 mass % or more, more preferably 0.03 mass % or more, and still more preferably 0.05 mass % or more based on the mass of the electrolyte solution. The content of the triazine compound in the electrolyte solution is preferably 5.0 mass % or less, more preferably 3.0 mass % or less, still more preferably 1.0 mass % or less, and even more preferably 0.5 mass % or less based on the mass of the electrolyte solution. The content of the triazine compound in the electrolyte solution may be within a range in which an arbitrary lower limit value and an arbitrary upper limit value, which are described above, are appropriately combined.

The triazine compound may be contained in any of the surface of the negative electrode, the surface of the positive electrode current collector, the inside of the positive electrode, the surface of the positive electrode, the surface and/or the inside of the separator, or the electrolyte solution as described above, or may be contained in two or more of these configurations. In a case where the triazine compound is contained in two or more of configurations among the surface of the negative electrode, the surface of the positive electrode current collector, the inside of the positive electrode, the surface of the positive electrode, the surface and/or the inside of the separator, and the electrolyte solution, preferred content and examples of the content of the triazine compound in each configuration are the same as those described above.

### Positive Electrode

The positive electrode 120 is not particularly limited insofar as it has a positive electrode active material and is a positive electrode commonly used in a lithium secondary battery, and a known material can be selected as needed, depending on the use of the lithium secondary battery. Because the positive electrode 120 has a positive electrode active material, the stability and the output voltage are high.

In the present specification, the “positive electrode active material” means a material used to retain a lithium element (typically, a lithium ion) in the positive electrode 120, and may be replaced by the term “a host material for the lithium element (typically, a lithium ion)”.

Such a positive electrode active material is not particularly limited and examples thereof include metal oxides and metal phosphates. The aforesaid metal oxides are not particularly limited and examples thereof include cobalt oxide-based compounds, manganese oxide-based compounds, and nickel oxide-based compounds. The aforesaid metal phosphates are not particularly limited and examples thereof include iron phosphate-based compounds and cobalt phosphate-based compounds. Examples of typical positive electrode active materials include LiCoO₂, LiNiₓCo_{y}Mn_{z}O (x+y+z=1), LiNiₓMn_{y}O (x+y=1), LiNiO₂, LiMn₂O₄, LiFePO, LiCoPO, LiFeOF, LiNiOF, and TiS₂. One or more of the aforesaid positive electrode active materials may be used either singly or in combination.

The positive electrode 120 may have a component other than the aforesaid positive electrode active material. Such a component is not particularly limited and examples thereof include known conductive additives, binders, solid polymer electrolytes, and inorganic solid electrolytes.

The conductive additive to be contained in the positive electrode 120 is not particularly limited and examples thereof include carbon black, single-wall carbon nanotube (SWCNT), multi-wall carbon nanotube (MWCNT), carbon nanofiber (CF), and acetylene black. The binder is not particularly limited and examples thereof include polyvinylidene fluoride, polytetrafluoroethylene, styrene butadiene rubber, acrylic resins, and polyimide resins.

The content of the positive electrode active material in the positive electrode 120 may be, for example, 50 mass % or more and 100 mass % or less based on the entire positive electrode 120. The content of the conductive additive may be, for example, 0.5 mass % or more and 30 mass % or less based on the entire positive electrode 120. The content of the binder in the total amount of the positive electrode 120 may be, for example, 0.5 mass % or more and 30 mass % or less. The total content of the solid polymer electrolyte and the inorganic solid electrolyte may be 0.5 mass % or more and 30 mass % or less based on the entire positive electrode 120.

The positive electrode 120 may contain the triazine compound therein with the aforementioned content. Alternatively, at least a part of the surface of the positive electrode 120 facing the negative electrode 130 may be coated with the triazine compound so that a proportion of the triazine compound to be applied is within the aforementioned range.

Positive Electrode Current Collector

The positive electrode current collector 110 is placed on one side of the positive electrode 120. The positive electrode current collector 110 is not particularly limited insofar as it is a conductor not reactive with a lithium ion in the battery. Examples of such a positive electrode current collector include aluminum.

The average thickness of the positive electrode current collector 110 is preferably 4 μm or more and 20 μm or less, more preferably 5 μm or more and 18 μm or less, and still more preferably 6 μm or more and 15 μm or less. In such a mode, an occupation volume of the positive electrode current collector 110 in the lithium secondary battery 100 decreases and the resulting lithium secondary battery 100 therefore has a more improved energy density.

At least a part of the surface of the positive electrode current collector 110 facing the negative electrode 130 may be coated with the triazine compound so that a proportion of the triazine compound to be applied is within the aforementioned range. In a case where the surface of the positive electrode current collector 110 is coated with the triazine compound, after coating the surface of the positive electrode current collector 110 with the triazine compound, the positive electrode 120 is formed on the surface having the coating.

### Separator

The separator 140 is a member for separating the positive electrode 120 from the negative electrode 130 to prevent a short circuit of the battery and in addition, for securing the ionic conductivity of a lithium ion which serves as a charge carrier between the positive electrode 120 and the negative electrode 130. It is composed of a material not having electronic conductivity and unreactive to lithium ion. The separator 140 also has a role of retaining electrolyte solution. There are no particular restrictions on the separator 140 insofar as it can play the aforesaid role. The separator 140 can be composed of, for example, a porous polyethylene (PE) film, a polypropylene (PP) film, or a laminated structure thereof.

The separator 140 may be covered with a separator coating layer. The separator coating layer may cover both of the surfaces of the separator 140 or may cover only one of them. The separator coating layer is not particularly limited insofar as it is a member having ionic conductivity and unreactive to a lithium ion and is preferably capable of firmly adhering the separator 140 to a layer adjacent to the separator 140. Such a separator coating layer is not particularly limited and examples thereof include members containing a binder such as polyvinylidene fluoride (PVDF), a composite material (SBR-CMC) of styrene butadiene rubber and carboxymethyl cellulose, polyacrylic acid (PAA), lithium polyacrylate (Li-PAA), polyimide (PI), polyamideimide (PAI), or aramid. The separator coating layer may be a member obtained by adding, to the aforesaid binder, inorganic particles such as silica, alumina, titania, zirconia, magnesium oxide, magnesium hydroxide, or lithium nitrate. The separator 140 may be a separator having no separator coating layer, or a separator having the separator cover layer.

The average thickness of the separator 140 is preferably 30 μm or less, more preferably 25 μm or less, and still more preferably 20 μm or less. In such a mode, the occupation volume of the separator 140 in the lithium secondary battery 100 decreases and therefore, the resulting lithium secondary battery 100 has a more improved energy density. The average thickness of the separator 140 is preferably 5 μm or more, more preferably 7 μm or more, and still more preferably 10 μm or more. In such a mode, the positive electrode 120 can be separated from the negative electrode 130 more reliably and a short circuit of the resulting battery can be suppressed further.

The separator 140 may contain the triazine compound therein with the aforementioned content. Alternatively, at least a part of the surface of the separator 140 may be coated with the triazine compound so that the content of the triazine compound is within the aforementioned range. In a case where the surface of the separator is coated with the triazine compound, the surface thereof may be a surface facing the negative electrode 130 or a surface facing the positive electrode 120.

### Electrolyte Solution

It is preferable that the lithium secondary battery 100 further has electrolyte solution. In the lithium secondary battery 100, the separator 140 may be wetted with the electrolyte solution or the electrolyte solution may be sealed together with a stacked body of the positive electrode current collector 110, the positive electrode 120, the separator 140, and the negative electrode 130 inside a hermetically sealed container. The electrolyte solution contains an electrolyte and a solvent. It is solution having ionic conductivity and serves as a conductive path of a lithium ion. Therefore, in the mode including the electrolyte solution, the internal resistance of the battery is further reduced, and the energy density, capacity, and cycle characteristics are further improved.

The solvent in the electrolyte solution is not particularly limited insofar as it is generally used in a lithium secondary battery, and a known solvent such as an organic solvent can be selected as needed, depending on the use of the lithium secondary battery. As the solvent in the lithium secondary battery 100, a fluorinated alkyl compound having at least one of a monovalent group represented by Formula (A) or a monovalent group represented by Formula (B) is preferable. That is, the lithium secondary battery 100 preferably contains such a fluorinated alkyl compound as a solvent.

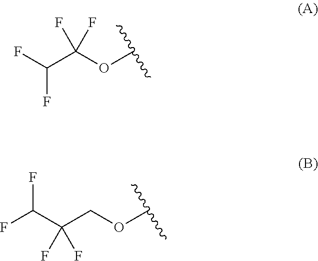 [SMILES: *OC(F)(F)C(F)F ; *OCC(F)(F)C(F)F]

Here, in the formulae, a wavy line represents a bonding site in the monovalent group.

Generally, in an anode-free lithium secondary battery having electrolyte solution, a solid electrolyte interfacial layer (SEI layer) is formed on the surface of a negative electrode or the like by decomposing solvent or the like in the electrolyte solution. Due to the SEI layer in the lithium secondary battery, further decomposition of components in the electrolyte solution, irreversible reduction of lithium ions caused by the decomposition, generation of gas, and the like are suppressed. In addition, because the SEI layer has ionic conductivity, reactivity of lithium-metal deposition reaction on the surface of the negative electrode, on which the SEI layer is formed, is uniform in a planar direction of the surface of the negative electrode. Therefore, promoting the formation of the SEI layer is very important for improving the performance of an anode-free lithium secondary battery.

The present inventors have found that, in the lithium secondary battery 100 containing the triazine compound, by using the aforesaid fluorinated alkyl compound as a solvent, the SEI layer is easily formed on the surface of the negative electrode, and the growth of dendritic lithium metal on the negative electrode is further suppressed, and thus the cycle characteristic is further improved. The factors are not necessarily clear, but the following factors can be considered.

It is considered that not only the lithium ions but also the aforesaid fluorinated alkyl compound as a solvent are reduced on the negative electrode during charge of the lithium secondary battery 100, particularly during initial charge. The portion represented by Formula (A) and the portion represented by Formula (B) in the fluorinated alkyl compound have high reactivity of oxygen atoms due to being substituted with a large number of fluorine. Therefore, it is presumed that a part or all of the portion represented by Formula (A) and the portion represented by Formula (B) are likely to be eliminated. As a result, during charge of the lithium secondary battery 100, a part or all of the portion represented by Formula (A) and the portion represented by Formula (B) are absorbed on the surface of the negative electrode, and since the SEI layer is formed starting from the absorbed portion, it is presumed that the SEI layer is likely to be formed in the lithium secondary battery 100. In addition, because the negative electrode 130 has the triazine compound that is presumed to interact with the lithium ion, it is considered that a large amount of stabilized lithium ions are present in the vicinity of the negative electrode when the SEI layer is formed, and an SEI layer having a high lithium element concentration is formed. As a result, in the lithium secondary battery 100 containing the triazine compound, by using the aforesaid fluorinated alkyl compound as a solvent, it is presumed that an SEI layer having an appropriate thickness and high ionic conductivity is easily formed, and thus the cycle characteristic is further improved.

Therefore, according to the mode of including the electrolyte solution containing the aforesaid fluorinated alkyl compound as a solvent, even though the SEI layer is easily formed, the internal resistance of the battery is low and the rate capability is excellent. That is, the cycle characteristic and the rate capability are further improved. The “rate capability” means a performance capable of charging/discharging with large current, and it is known that the rate capability is excellent when the internal resistance of the battery is low.

A compound “contained as a solvent” as used herein means that, in the usage environment of lithium secondary batteries, it is sufficient that the compound alone or a mixture of the compound with other compounds is a liquid, and furthermore, it is sufficient that the electrolyte can be dissolved to form electrolyte solution in solution phase.

Examples of such a fluorinated alkyl compound include compounds having an ether bond (which will hereinafter be called “ether compounds”), compounds having an ester bond, and compounds having a carbonate bond. From the standpoint of further improving solubility of the electrolyte in the electrolyte solution and from the standpoint that the SEI layer is more easily formed, the fluorinated alkyl compound is preferably an ether compound.

Examples of the ether compound as the fluorinated alkyl compound include ether compounds having both the monovalent group represented by Formula (A) and the monovalent group represented by Formula (B) (which will hereinafter also be called “first fluorine solvents”), ether compounds that have the monovalent group represented by Formula (A) and does not have the monovalent group represented by Formula (B) (which will hereinafter also be called “second fluorine solvents”), and ether compounds that do not have the monovalent group represented by Formula (A) and has the monovalent group represented by Formula (B) (which will hereinafter also be called “third fluorine solvents”).

Examples of the first fluorine solvents include 1,1,2,2-tetrafluoroethyl-2,2,3,3-tetrafluoropropyl ether, 1,1,2,2-tetrafluoroethyl-2,2,3,3-tetrafluoropropyl diethoxymethane, and 1,1,2,2-tetrafluoroethyl-2,2,3,3-tetrafluoropropyl diethoxypropane. From the standpoint of effectively and reliably exhibiting the effects of fluorinated alkyl compound mentioned above, 1,1,2,2-tetrafluoroethyl-2,2,3,3-tetrafluoropropyl ether is preferable as the first fluorine solvent.

Examples of the second fluorine solvents include 1,1,2,2-tetrafluoroethyl-2,2,2-trifluoroethyl ether, methyl-1,1,2,2-tetrafluoroethyl ether, ethyl-1,1,2,2-tetrafluoroethyl ether, propyl-1,1,2,2-tetrafluoroethyl ether, 1H,1H,5H-perfluoropentyl-1,1,2,2-tetrafluoroethyl ether, and 1H,1H,5H-octafluoropentyl-1,1,2,2-tetrafluoroethyl ether. From the standpoint of effectively and reliably exhibiting the effects of fluorinated alkyl compound mentioned above, 1,1,2,2-tetrafluoroethyl-2,2,2-trifluoroethyl ether, methyl-1,1,2,2-tetrafluoroethyl ether, ethyl-1,1,2,2-tetrafluoroethyl ether, or 1H,1H,5H-octafluoropentyl-1,1,2,2-tetrafluoroethyl ether is preferable as the second fluorine solvent.

Examples of the third fluorine solvents include difluoromethyl-2,2,3,3-tetrafluoropropyl ether, trifluoromethyl-2,2,3,3-tetrafluoropropyl ether, fluoromethyl-2,2,3,3-tetrafluoropropyl ether, and methyl-2,2,3,3-tetrafluoropropyl ether. From the standpoint of effectively and reliably exhibiting the effects of fluorinated alkyl compound mentioned above, difluoromethyl-2,2,3,3-tetrafluoropropyl ether is preferable as the third fluorine solvent.

The electrolyte solution may contain a solvent having neither the monovalent group represented by Formula (A) nor the monovalent group represented by Formula (B). Such a solvent is not particularly limited and examples thereof include solvents not containing fluorine, such as dimethyl ether, triethylene glycol dimethyl ether, dimethoxyethane, diethylene glycol dimethyl ether, acetonitrile, dimethyl carbonate, diethyl carbonate, ethyl methyl carbonate, ethylene carbonate, propylene carbonate, chloroethylene carbonate, methyl acetate, ethyl acetate, propyl acetate, methyl propionate, ethyl propionate, trimethyl phosphate, and triethyl phosphate; and solvents containing fluorine, such as methyl nonafluorobutyl ether, ethyl nonafluorobutyl ether, 1,1,1,2,2,3,4,5,5,5-decafluoro-3-methoxy-4-trifluoromethylpentane, methyl-2,2,3,3,3-pentafluoropropyl ether, 1,1,2,3,3,3-hexafluoropropyl methyl ether, ethyl-1,1,2,3,3,3-hexafluoropropyl ether, and tetrafluoroethyl tetrafluoropropyl ether.

One or more of the solvents described above, including the aforesaid fluorinated alkyl compound, may be used either singly or in combination.

The content of the fluorinated alkyl compound in the electrolyte solution is not particularly limited, but is, based on the total amount of the solvent components in the electrolyte solution, preferably 40 vol. % or more, more preferably 50 vol. % or more, still more preferably 60 vol. % or more, and even more preferably 70 vol. % or more. When the content of the fluorinated alkyl compound is within the aforesaid range, because the SEI layer is more easily formed, the cycle characteristic of the battery tends to be further improved. The upper limit of the content of the fluorinated alkyl compound is not particularly limited, and the content of the fluorinated alkyl compound may be 100 vol. % or less, 95 vol. % or less, 90 vol. % or less, or 80 vol. % or less based on the total amount of the solvent components in the electrolyte solution. The content of the fluorinated alkyl compound may be within a range in which an arbitrary lower limit value and an arbitrary upper limit value, which are described above, are appropriately combined.

There are no particular restrictions on the electrolyte which is contained in the electrolyte solution insofar as it is a salt. Examples of the electrolyte include salts of Li, Na, K, Ca, and Mg. As the electrolyte, a lithium salt is preferred. The lithium salt is not particularly limited and examples thereof include LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiBF₂(C₂O₄), LiB(O₂C₂H₄)₂, LiB(O₂C₂H₄)F₂, LiB(OCOCF₃)₄, LiNO₃, and Li₂SO₄. One or more of the aforesaid lithium salts may be used either singly or in combination.

The concentration of the electrolyte in the electrolyte solution is not particularly limited, but is preferably 0.5 M or more, more preferably 0.7 M or more, still more preferably 0.9 M or more, and even more preferably 1.0 M or more. When the concentration of the electrolyte is within the aforesaid range, the SEI layer is more easily formed and the internal resistance tends to be further reduced. The upper limit of the concentration of the electrolyte is not particularly limited, and the concentration of the electrolyte may be 10.0 M or less, 5.0 M or less, or 2.0 M or less. The concentration of the electrolyte solution may be within a range in which an arbitrary lower limit value and an arbitrary upper limit value, which are described above, are appropriately combined.

The electrolyte solution preferably contains the triazine compound. In such a mode, the cycle characteristic of the battery tends to be further improved.

### Use of Lithium Secondary Battery

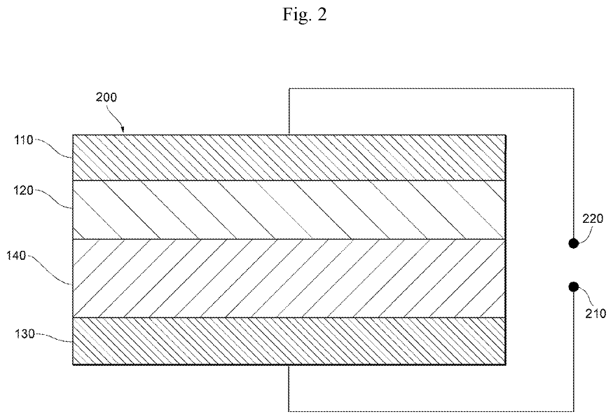

FIG. 2 shows one mode of the use of the lithium secondary battery of the present embodiment. With respect to the lithium secondary battery 100, the lithium secondary battery 200 has a positive electrode terminal 220 and a negative electrode terminal 210 for connecting the lithium secondary battery to an external circuit and these terminals are bonded to the positive electrode current collector 110 and the negative electrode 130, respectively. The lithium secondary battery 200 is charged/discharged by connecting the negative electrode terminal 210 to one end of the external circuit and the positive electrode terminal 220 to the other end of the external circuit.

The lithium secondary battery 200 is charged by applying a voltage between the positive electrode terminal 220 and the negative electrode terminal 210 to cause a current flow from the negative electrode terminal 210 to the positive electrode terminal 220 through the external circuit. By charging the lithium secondary battery 200, the lithium metal deposits on the negative electrode.

In the lithium secondary battery 200, the solid electrolyte interfacial layer (SEI layer) may be formed on the surface of the negative electrode 130 (at the interface between the negative electrode 130 and the separator 140), by the first charge (initial charge) after assembling the battery. The SEI layer to be formed is not particularly limited and it may contain a lithium-containing inorganic compound or a lithium-containing organic compound. The typical average thickness of the SEI layer is 1 nm or more and 10 μm or less.

When the positive electrode terminal 220 and the negative electrode terminal 210 are connected to the charged lithium secondary battery 200, the lithium secondary battery 200 is discharged. As a result, the deposition of the lithium metal generated on the negative electrode is electrolytically eluted.

### Method of Manufacturing Lithium Secondary Battery

A method of manufacturing the lithium secondary battery 100 as shown in FIG. 1 is not particularly limited insofar as it can provide a lithium secondary battery equipped with the aforesaid configuration and examples of the method include the method as follows.

First, the positive electrode 120 is prepared by a known manufacturing method or by purchasing a commercially available one. The positive electrode 120 may be manufactured in the following manner. Such a positive electrode active material as mentioned above, a known conductive additive, and a known binder are mixed together to obtain a positive electrode mixture. The mixing ratio of them may be, for example, 50 mass % or more and 99 mass % or less of the positive electrode active material, 0.5 mass % or more and 30 mass % or less of the conductive additive, and 0.5 mass % or more and 30 mass % or less of the binder based on the entire positive electrode mixture. The positive electrode mixture thus obtained is applied onto one of the surfaces of a metal foil (for example, Al foil) serving as a positive electrode current collector and having a predetermined thickness (for example, 5 μm or more and 1 mm or less), followed by press molding. The molded material thus obtained is punched into a predetermined size to obtain a positive electrode 120 formed on a positive electrode current collector 110.

In a case where the surface of the positive electrode current collector 110 is to be coated with the triazine compound, before forming the positive electrode 120, the washed positive electrode current collector may be immersed in a solution containing the triazine compound (for example, an aqueous solution having 0.01 vol. % or more and 10 vol. % or less of the triazine compound), and then dried in the atmosphere, thereby performing the coating. At this time, by masking one surface of the positive electrode current collector, the triazine compound may be applied onto only one surface.

In a case where the positive electrode 120 contains the triazine compound, the triazine compound may be further added in the step of obtaining the aforesaid positive electrode mixture. The addition amount of the triazine compound may be 0.01 mass % or more and 3.0 mass % or less, 0.03 mass % or more and 1.0 mass % or less, and 0.05 mass % or more and 0.5 mass % or less based on the entire positive electrode mixture.

In a case where the surface of the positive electrode is coated with the triazine compound, the triazine compound, a known conductive additive, and/or a known binder may be mixed to obtain a slurry, and the surface of the positive electrode may be coated with the slurry.

Next, the negative electrode 130 can be prepared by washing the aforesaid negative electrode material, such as a metal foil (for example, an electrolytic Cu foil) having a thickness of 1 μm or more and 1 mm or less, with a sulfamic-acid-containing solvent.

In a case where the surface of the negative electrode 130 is to be coated with the triazine compound, the negative electrode obtained as described above may be further washed with a dilute sulfuric acid, immersed in a commercially available washing agent containing the triazine compound (the content of the triazine compound is, for example, 0.01 vol. % or more and 10 vol. % or less) for 1 to 10 minutes, and then dried in the atmosphere, thereby performing the coating. At this time, by masking one surface of the negative electrode, the triazine compound may be applied onto only one surface.

In a case where the negative electrode 130 or the positive electrode current collector 110 is coated with the triazine compound, for example, a roll-to-roll method may be used for the step of immersing the electrode plate in the solution containing the triazine compound, or the like.

Next, a separator 140 having the aforesaid configuration is prepared. As the separator 140, a separator manufactured by a conventionally known method or a commercially available one may be used.

In a case where the triazine compound is to be contained inside the separator, the separator may be immersed in a solution containing the triazine compound (for example, an aqueous solution having 0.01 vol. % or more and 10 vol. % or less of the triazine compound), and then dried to contain the triazine compound.

In a case where the surface of the separator is coated with the triazine compound, the separator may be coated with a slurry which is obtained by mixing the aforesaid resin such as polyvinylidene fluoride (PVDF), which may be contained in the separator cover layer, a filler such as alumina, which may be contained in the separator cover layer, the triazine compound, and the like. The content of the triazine compound in the slurry may be, for example, 1 mass % or more and 20 mass % or less based on the entire slurry.

The electrolyte solution may be prepared by dissolving the aforesaid electrolyte (typically, a lithium salt) in the aforesaid solvent.

In a case where the electrolyte solution contains the triazine compound, the triazine compound may be added to the electrolyte solution so that the content of the triazine compound is within the aforementioned range.

The triazine compound may be contained in at least one of the surface of the negative electrode, the surface of the positive electrode current collector, the inside of the positive electrode, the surface of the positive electrode, the surface and/or the inside of the separator, or the electrolyte solution as described above.

The positive electrode current collector 110 on which the positive electrode 120 is formed, the separator 140, and the negative electrode 130, which are obtained as described above, are stacked in order of mention to obtain a stacked body as shown in FIG. 1. The stacked body obtained as described above is encapsulated, together with the electrolyte solution in a hermetically sealing container to obtain a lithium secondary battery 100. The hermetically sealing container is not particularly limited and examples thereof include a laminate film.

### Second Embodiment

### Lithium Secondary Battery

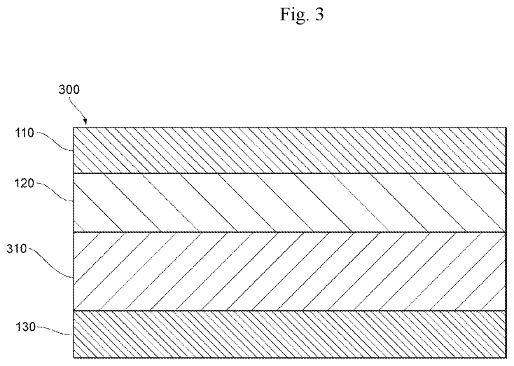

FIG. 3 is a schematic cross-sectional view of the lithium secondary battery of Second Embodiment. The lithium secondary battery 300 in Second Embodiment has a positive electrode 120 and a negative electrode 130 not having a negative electrode active material. In addition, in the lithium secondary battery 300, a positive electrode current collector 110 is placed on a side of the positive electrode 120, opposite to a surface facing the negative electrode 130, and a solid electrolyte 310 is placed between the positive electrode 120 and the negative electrode 130. The lithium secondary battery 300 may include an electrolyte solution as included in the lithium secondary battery 100.

The lithium secondary battery 300 further contains a compound having a 1,3,5-triazine ring skeleton (“triazine compound”), which is not shown in FIG. 3. It is sufficient that the triazine compound is contained in any one or more of components of the lithium secondary battery 300. Therefore, for example, the triazine compound may be applied onto at least a part of the surface of the positive electrode current collector 110 facing the negative electrode 130, may be contained in the positive electrode 120, may be applied onto at least a part of the surface of the negative electrode 130 facing the positive electrode 120, or may be contained in the surface of the solid electrolyte 310 or inside the solid electrolyte 310. The surface of the solid electrolyte 310 may be on the negative electrode 130 or on the positive electrode 120 side. In a case where the lithium secondary battery 300 has an electrolyte solution, the triazine compound may be contained in the electrolyte solution.

The configuration, examples, and preferred modes of the positive electrode current collector 110, the positive electrode 120, the negative electrode 130, and the triazine compound are the same as those of the lithium secondary battery 100 in First Embodiment. The lithium secondary battery 300 has the same effects as the lithium secondary battery 100 described above.

Hereinafter, only the configuration of the lithium secondary battery 300, which is different from the lithium secondary battery 100 in First Embodiment, will be described.

### Solid Electrolyte

In general, a battery containing liquid electrolyte tends to be exposed to different physical pressures, which are applied from the electrolyte to the surface of a negative electrode, at different locations due to the shaking of the liquid. On the other hand, since the lithium secondary battery 300 has the solid electrolyte 310, a pressure applied from the solid electrolyte 310 to the surface of the negative electrode 130 becomes uniform and the shape of a lithium metal deposited on the surface of the negative electrode 130 can be made more uniform. This means that in such a mode, a lithium metal which deposits on the surface of the negative electrode 130 is suppressed further from growing into a dendritic form and the resulting lithium secondary battery 300 therefore has a more excellent cycle characteristic.

The solid electrolyte 310 is not particularly limited insofar as it is used generally for a lithium solid secondary battery and a known material can be selected as needed, depending on the use of the lithium secondary battery 300. The solid electrolyte 310 preferably has ionic conductivity and no electric conductivity. Since the solid electrolyte 310 has ionic conductivity and no electric conductivity, the resulting lithium secondary battery 300 has more reduced internal resistance and in addition, the lithium secondary battery 300 is prevented from causing a short circuit inside thereof. As a result, the lithium secondary battery 300 therefore has a more excellent energy density, capacity, and cycle characteristic.

As the solid electrolyte 310, an electrolyte containing a resin and a lithium salt (gel electrolyte) is preferable. The resin is not particularly limited and examples thereof include resins having an ethylene oxide unit in a main chain and/or a side chain, acrylic resins, vinyl resins, ester resins, nylon resins, polysiloxanes, polyphosphazene, polyvinylidene fluoride, polymethyl methacrylate, polyamides, polyimides, aramids, polylactic acid, polyethylenes, polystyrenes, polyurethanes, polypropylenes, polybutylenes, polyacetals, polysulfones, and polytetrafluoroethylene. Alternatively, the resin may be a copolymer of polyethylene and/or polyethylene oxide, polyvinylidene fluoride, a copolymer of polyvinylidene fluoride and hexafluoropropyrene, or the like. One or more of the aforesaid resins may be used either singly or in combination.

The lithium salt contained in the gel electrolyte is not particularly limited and examples thereof include salts as lithium salts that can be contained in the electrolyte solution of the lithium secondary battery 100 mentioned above. One or more of the aforesaid lithium salts may be used either singly or in combination.

Generally, the content ratio of the lithium salt to the resin in the gel electrolyte is determined by a ratio ([Li]/[O]) of lithium atoms of the lithium salt to oxygen atoms of the resin. In the gel electrolyte, a content ratio of the lithium salt to the resin is adjusted so that the aforesaid ratio ([Li]/[O]) is preferably 0.02 or more and 0.20 or less, more preferably 0.03 or more and 0.15 or less, and still more preferably 0.04 or more and 0.12 or less.

The gel electrolyte may contain a component other than the aforesaid resin and lithium salt. Such a component is not particularly limited and examples thereof include solvents and salts other than lithium salts. The salts other than lithium salts are not particularly limited and examples thereof include salts of Na, K, Ca, and Mg. The solvent is not particularly limited and examples thereof include those mentioned as the solvent of the electrolyte solution which can be contained in the lithium secondary battery 100. One or more of these solvents and salts other than lithium salts may be used either singly or in combination.

The average thickness of the solid electrolyte 310 is preferably 20 μm or less, more preferably 18 μm or less, and still more preferably 15 μm or less. In such a mode, an occupation volume of the solid electrolyte 310 in the lithium secondary battery 300 decreases so that the resulting lithium secondary battery 300 has a more improved energy density. In addition, the average thickness of the solid electrolyte 310 is preferably 5 μm or more, more preferably 7 μm or more, and still more preferably 10 μm or more. In such a mode, the positive electrode 120 can be separated from the negative electrode 130 more reliably and a short circuit of the resulting battery can be suppressed further.

The solid electrolyte 310 may contain the triazine compound therein. Alternatively, at least a part of the surface of the solid electrolyte 310 may be coated with the triazine compound. In a case where the surface of the solid electrolyte is coated with the triazine compound, the surface thereof may be a surface facing the negative electrode 130 or a surface facing the positive electrode 120.

The content of the triazine compound in the solid electrolyte is preferably 0.01 mass % or more, more preferably 0.03 mass % or more, and still more preferably 0.05 mass % or more based on the mass of the solid electrolyte. The content of the triazine compound in the solid electrolyte is preferably 5.0 mass % or less, more preferably 3.0 mass % or less, still more preferably 1.0 mass % or less, and even more preferably 0.5 mass % or less based on the mass of the solid electrolyte. The content of the triazine compound in the solid electrolyte may be within a range in which an arbitrary lower limit value and an arbitrary upper limit value, which are described above, are appropriately combined.

The triazine compound may be contained in any of the surface of the negative electrode, the surface of the positive electrode current collector, the inside of the positive electrode, the surface of the positive electrode, the surface and/or the inside of the solid electrolyte, or the electrolyte solution, or may be contained in two or more of these configurations. In a case where the triazine compound is contained in two or more of configurations among the surface of the negative electrode, the surface of the positive electrode current collector, the inside of the positive electrode, the surface of the positive electrode, the surface and/or the inside of the solid electrolyte, and the electrolyte solution, preferred content and examples of the content of the triazine compound in each configuration are the same as those described above.

### Method of Manufacturing Secondary Battery

The lithium secondary battery 300 can be manufactured in a manner similar to that of the lithium secondary battery 100 of First Embodiment, except for the use of the solid electrolyte instead of the separator.

The method of manufacturing the solid electrolyte 310 is not particularly limited insofar as it is a method capable of providing the aforesaid solid electrolyte 310 and it may be performed, for example, as follows. A resin and a lithium salt conventionally used for a gel electrolyte (for example, the aforesaid resin as a resin which can be contained in the solid electrolyte 310, and a lithium salt) are dissolved in an organic solvent (for example, N-methylpyrrolidone or acetonitrile). The solution thus obtained is cast on a molding substrate to have a predetermined thickness and thus, the solid electrolyte 310 is obtained. The mixing ratio of the resin and the lithium salt may be determined based on the ratio ([Li]/[O]) of lithium atoms of the lithium salt to oxygen atoms of the resin, as described above. The aforesaid ratio ([Li]/[O]) is, for example, 0.02 or more and 0.20 or less. The molding substrate is not particularly limited and, for example, a PET film or a glass substrate may be used.

In a case where the triazine compound is to be contained inside the solid electrolyte, the solid electrolyte may be immersed in a solution containing the triazine compound (for example, an aqueous solution having 0.01 vol. % or more and 10 vol. % or less of the triazine compound), and then dried to contain the triazine compound.

In a case where the surface of the solid electrolyte is coated with the triazine compound, the solid electrolyte may be coated with a slurry which is obtained by mixing the aforesaid resin which may be contained in the solid electrolyte, a lithium salt which may be contained in the solid electrolyte, the triazine compound, and the like. The content of the triazine compound in the slurry may be, for example, 1 mass % or more and 20 mass % or less based on the entire slurry.

### Modification Example

The aforesaid present embodiments are examples for describing the present invention. They do not intend to limit the present invention only thereto and the present invention may have various modifications without departing from the gist thereof

For example, in the lithium secondary battery 100 of First Embodiment, the separator 140 may be formed on both surfaces of the negative electrode 130. In this case, the lithium secondary battery has a structure in which the following components are stacked in order of mention: positive electrode current collector/positive electrode/separator/negative electrode/separator/positive electrode/positive electrode current collector. The lithium secondary battery in such a mode has more improved capacity.

The lithium secondary battery 300 may be a lithium solid secondary battery. A battery in such a mode does not need electrolyte solution so that it is free from a problem of electrolyte solution leakage and has more improved safety.

The lithium secondary battery 100 may not have the separator 140. In such a case, it is desirable that the positive electrode 120 and the negative electrode 130 are fixed at a sufficient distance so as not to cause a short circuit of the battery due to contact between the positive electrode 120 and the negative electrode 130.

In the lithium secondary batteries in the embodiments, a terminal for connecting to an external circuit may be attached to the positive electrode current collector and/or the negative electrode. For example, a metal terminal (for example, Al, Ni, or the like) having a length of 10 μm or more and 1 mm or less may be bonded to one or both of the positive electrode current collector and the negative electrode. For bonding, a conventionally known method may be used and for example, ultrasonic welding is usable.

The term “an energy density is high” or “has a high energy density” as used herein means that the capacity of a battery per total volume or total mass is high. It is preferably 800 Wh/L or more or 350 Wh/kg or more, more preferably 900 Wh/L or more or 400 Wh/kg or more, and still more preferably 1000 Wh/L or more or 450 Wh/kg or more.

The term “having an excellent cycle characteristic” as used herein means that a decreasing ratio of the capacity of a battery is small before and after the expected number of charging/discharging cycles in ordinary use. Described specifically, it means that when a first discharge capacity after the initial charge and a discharge capacity after the number of charging/discharging cycles expected in ordinary use are compared, the discharge capacity after charging/discharging cycles has hardly decreased compared with the first discharge capacity after the initial charge. The “number expected in ordinary use” varies depending on the usage of the lithium secondary battery and it is, for example, 30 times, 50 times, 70 times, 100 times, 300 times, or 500 times. The term “discharge capacity after charging/discharging cycles hardly decreased compared with the first discharge capacity after the initial charge” means, though differing depending on the usage of the lithium secondary battery, that the discharge capacity after charging/discharging cycles is, for example, 60% or more, 65% or more, 70% or more, 75% or more, 80% or more, or 85% or more, each in the first discharge capacity after the initial charge.

### EXAMPLES

The present invention will hereinafter be described in detail by Examples and Comparative Examples. The present invention is not limited by the following Examples.

### Method of Manufacturing Lithium Secondary Battery

The respective steps for manufacturing a lithium secondary battery were performed as follows.

### Production of Negative Electrode

A 10 μm electrolytic Cu foil was washed with a dilute sulfuric acid, immersed in a commercially available washing agent for 2 minutes, and then dried. The electrode thus obtained was punched into a predetermined size (45 mm×45 mm) to obtain a negative electrode.

In a case where the surface of the negative electrode was to be coated with the triazine compound, in the step of immersing the electrolytic Cu foil in the washing agent, the triazine compound was added to the washing agent so as to be an amount of 0.05 mass %. The surface of the negative electrode was coated with the triazine compound by immersing the electrode in the washing agent containing the triazine compound.

### Production of Separator

An aqueous slurry containing alumina, polyvinylidene fluoride (PVDF), a dispersant, and a surfactant was applied onto both surfaces of a 12 μm polyethylene microporous film (50 mm×50 mm) using a comma coater, and the resulting film was dried in a drying oven kept at 60° C. to produce a separator. The applied amount of the slurry was adjusted so that a separator cover layer had a thickness of 2 μm.

In a case where the surface of the separator was to be coated with the triazine compound, in the step of applying the slurry, the triazine compound was added to the slurry so that the content of the triazine compound in the slurry was 10 mass %. The surface of the separator was coated with the triazine compound by applying the slurry containing the triazine compound.

### Production of Positive Electrode

96.0 parts by mass of LiNi_{0.90}Co_{0.08}Al_{0.02}O₂ as a positive electrode active material, 0.5 parts by mass of carbon nanotube and 1.0 parts by mass of acetylene black as a conductive additive, and 2.5 parts by mass of polyvinylidene fluoride (PVDF) as a binder were mixed with each other to obtain a positive electrode mixture. The obtained positive electrode mixture was applied onto one side of a 12 μm Al foil as a positive electrode current collector, followed by pressing molding. The molded material thus obtained was punched into a predetermined size (40 mm×40 mm) to obtain a positive electrode formed on the positive electrode current collector.

In a case of producing a positive electrode containing the triazine compound, the triazine compound was added to the aforesaid positive electrode mixture so that the content of the triazine compound was 0.1 mass % based on the entire positive electrode mixture. The positive electrode containing the triazine compound was produced by producing the positive electrode with the positive electrode mixture containing the triazine compound.

### Preparation of Electrolyte Solution

As electrolyte solution, LiN(SO₂F)₂ (LiFSI) was dissolved in a mixed solvent of dimethoxyethane (DME) and 1,1,2,2-tetrafluoroethyl-2,2,3,3-tetrafluoropropyl ether (TTFE) (mixing ratio was DME:TTFE=20:80 vol. %) to prepare a 1.2 M LiFSI solution.

In a case of preparing electrolyte solution containing the triazine compound, the triazine compound was added to the aforesaid electrolyte solution so that the concentration of the triazine compound was a predetermined value shown in Table 1 described later.

### Assembly of Battery

Then, a stacked body was obtained by stacking the positive electrode formed on the positive electrode current collector, the separator, and the negative electrode in order of mention. A 100 μm Al terminal and a 100 μm Ni terminal were connected to the positive electrode current collector and the negative electrode by ultrasonic welding, respectively, and then the laminate was inserted into a laminated outer container. Next, the aforesaid electrolyte solution was injected into an outer container. The resulting outer container was hermetically sealed to obtain a lithium secondary battery.

### Triazine Compound

As the triazine compound, compounds represented by Formulae (I) to (V) were used. In the following, for example, a compound represented by Formula (I) will be referred to as “compound (I)”.

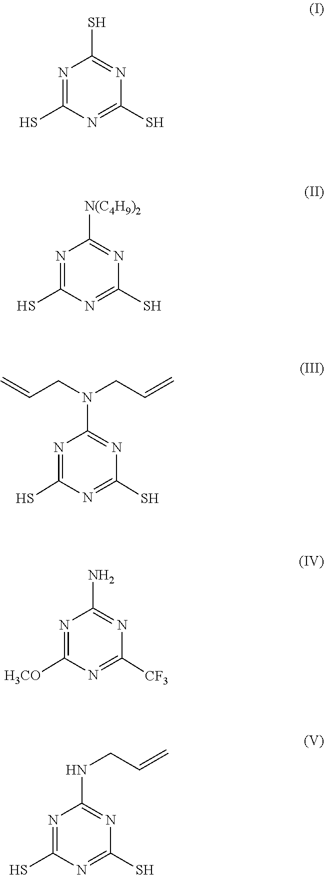

### Example 1

A lithium secondary battery was produced by the aforesaid procedure. As the negative electrode, a negative electrode in which the surface of the negative electrode was coated with the compound (I) was used, and no triazine compound was added to the separator, the positive electrode, and the electrolyte solution.

### Examples 2 to 19

Lithium secondary batteries were produced in the same manner as in Example 1. In each example, as the component (the negative electrode, the separator, the positive electrode, or the electrolyte solution) shown in Table 1, a component containing the triazine compound shown in Table 1 (any one of the compounds (I) to (V)) was used. In the table, “-” means each component did not contain the triazine compound. In addition, “Concentration (mass %)” means the concentration (mass %) of the triazine compound in the electrolyte solution. Therefore, for example, in Example 11, a lithium secondary battery was produced with electrolyte solution containing 0.05 mass % of the compound (I), and a negative electrode, a positive electrode, and a separator, which did not contain the triazine compound.

### Comparative Example 1

As shown in Table 1, a lithium secondary battery was produced using each component of the battery, which did not contain the triazine compound.

### Evaluation of Capacity and Cycle Characteristic

The capacity and cycle characteristic of each of the lithium secondary batteries produced in Examples and Comparative Examples were evaluated as follows.

The produced lithium secondary battery was CC-charged at 3.2 mA until the voltage reached 4.2 V (initial charge), and then CC-discharged at 3.2 mA until the voltage reached 3.0 V (which will hereinafter be called “initial discharge”). Next, a cycle of CC-charging at 13.6 mA until the voltage reached 4.2 V and then CC-discharging at 20.4 mA until the voltage reached 3.0 V was repeated at a temperature of 25° C. Table 1 shows the capacity (which will hereinafter be called “initial capacity”) obtained from the initial discharging for each example. For the examples, the number of cycles (referred to as “Cycle (times)” in the table) when the discharge capacity reached 80% of the initial capacity is shown in Table 1.

### Measurement of Direct Current Resistance

The produced lithium secondary battery was CC-charged at 5.0 mA to 4.2 V, and then CC-discharged at 30 mA, 60 mA, and 90 mA for 30 seconds, respectively. At this time, the lower limit voltage was set to 2.5 V, but in any of the examples, the voltage did not reach 2.5 V by the discharging for 30 seconds. In addition, between each discharging, CC-charging was performed again at 5.0 mA to 4.2 V, and the next CC-discharging was performed after the charging was completed. The direct current resistance (DCR) (unit: Ω) was obtained from the gradient of I-V characteristic obtained plotting a current value I and a voltage drop V obtained as described above, and linearly approximating each point. The results for each example are shown in Table 1.

TABLE 1

| | Triazine compound | | | | | Characteristics | | |
|---|---|---|---|---|---|---|---|---|
| | Nega- | | Positive | Electro- | Concen- | Capa- | | |
| | tive | Separ- | elec- | lyte | tration | city | DCR | Cycle |
| Sample No. | electrode | ator | trode | solution | (mass %) | (mAh) | (Ω) | (times) |
| Example 1 | I | — | — | — | — | 68 | 4.05 | 190 |
| Example 2 | II | — | — | — | — | 67 | 4.00 | 188 |
| Example 3 | III | — | — | — | — | 68 | 4.10 | 195 |
| Example 4 | IV | — | — | — | — | 67 | 4.20 | 191 |
| Example 5 | V | — | — | — | — | 69 | 4.30 | 193 |
| Example 6 | — | I | — | — | — | 68 | 3.96 | 176 |
| Example 7 | — | II | — | — | — | 67 | 4.10 | 172 |
| Example 8 | — | III | — | — | — | 67 | 4.20 | 174 |
| Example 9 | — | IV | — | — | — | 68 | 4.30 | 178 |
| Example 10 | — | V | — | — | — | 66 | 4.80 | 177 |
| Example 11 | — | — | — | I | 0.05 | 67 | 3.98 | 193 |
| Example 12 | — | — | — | II | 0.1 | 67 | 3.99 | 197 |
| Example 13 | — | — | — | III | 0.5 | 68 | 4.05 | 196 |
| Example 14 | — | — | — | IV | 0.05 | 68 | 4.10 | 189 |
| Example 15 | — | — | — | IV | 0.1 | 68 | 4.10 | 196 |
| Example 16 | — | — | — | IV | 2.0 | 68 | 4.30 | 190 |
| Example 17 | — | — | — | V | 0.05 | 68 | 3.60 | 169 |
| Example 18 | — | — | IV | — | — | 68 | 4.30 | 158 |
| Example 19 | — | — | V | — | — | 68 | 3.60 | 149 |
| Comparative | — | — | — | — | — | 68 | 3.68 | 135 |
| Example 1 | | | | | | | | |

From Table 1, in Examples of containing the triazine compound, as compared with Comparative Example 1 of not containing the triazine compound, it was found that the number of cycles was higher and the cycle characteristic was more excellent. In addition, in Examples of containing the triazine compound, as compared with Comparative Example 1 of not containing the triazine compound, it was found that the direct current resistance was about the same and the rate capability did not deteriorate even if the triazine compound was contained. That is, it was found that the lithium secondary battery of the present invention was excellent in cycle characteristic and rate capability.

From Table 1, it was found that, in the mode in which the triazine compound was applied onto the negative electrode or contained in the electrolyte solution, the cycle characteristic was particularly excellent.

The lithium secondary battery of the present invention has a high energy density and an excellent cycle characteristic so that it has industrial applicability as a power storage device to be used for various uses.
100, 200, 300 . . . lithium secondary battery
110 . . . positive electrode current collector
120 . . . positive electrode
130 . . . negative electrode
140 . . . separator
210 . . . negative electrode terminal
220 . . . positive electrode terminal
310 . . . solid electrolyte

What is claimed is:

1. A lithium secondary battery, comprising:
a positive electrode; and
a negative electrode not having a negative electrode active material;
wherein the lithium secondary battery comprises a compound having a 1,3,5-triazine ring skeleton.

2. The lithium secondary battery according to claim 1, wherein the compound is a compound in which at least one thiol group is bonded to the 1,3,5-triazine ring skeleton.

3. The lithium secondary battery according to claim 1;
wherein the compound has a 1,3,5-triazine ring skeleton having substituents at all of a 2-position, a 4-position, and a 6-position; and
the substituents are selected from the group consisting of a monovalent hydrocarbon group which may be substituted with a halogen atom; a hydroxy group; an alkoxy group; a thiol group; and an amino group which may be substituted with an unsubstituted hydrocarbon group.

4. The lithium secondary battery according to claim 1, wherein the compound is a compound in which at least two thiol groups are bonded to the 1,3,5-triazine ring skeleton.

5. The lithium secondary battery according to claim 1, further comprising:
a separator or a solid electrolyte which is placed between the positive electrode and the negative electrode.

6. The lithium secondary battery according to claim 1, wherein at least a part of the compound is applied onto at least a part of a surface of the negative electrode facing the positive electrode.

7. The lithium secondary battery according to claim 3, further comprising:
electrolyte solution;
wherein the electrolyte solution comprises the compound.

8. The lithium secondary battery according to claim 1, further comprising:
electrolyte solution;
wherein the electrolyte solution comprises, as a solvent, a compound having at least one of a monovalent group represented by Formula (A) or a monovalent group represented by Formula (B): 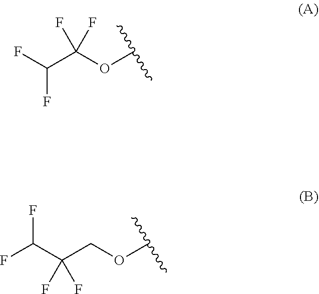 [SMILES: *OC(F)(F)C(F)F ; *OCC(F)(F)C(F)F]
(in the formulae, a wavy line represents a bonding site in the monovalent group.)

9. The lithium secondary battery according to claim 1, wherein the lithium secondary battery is a lithium secondary battery in which charging and discharging are performed by depositing lithium metal on the surface of the negative electrode and electrolytically dissolving the deposited lithium.

10. The lithium secondary battery according to claim 1, wherein the negative electrode is an electrode consisting of at least one selected from the group consisting of Cu, Ni, Ti, Fe, and other metals that do not react with Li, alloys thereof, and stainless steel (SUS).

11. The lithium secondary battery according to claim 1, wherein the negative electrode does not have a lithium metal on a surface of the negative electrode before initial charge and/or at an end of discharge.

12. The lithium secondary battery according to claim 1, wherein the battery has an energy density of 350 Wh/kg or more.

13. The lithium secondary battery according to claim 2;
wherein the compound has a 1,3,5-triazine ring skeleton having substituents at all of a 2-position, a 4-position, and a 6-position; and
the substituents are selected from the group consisting of a monovalent hydrocarbon group which may be substituted with a halogen atom; a hydroxy group; an alkoxy group; a thiol group; and an amino group which may be substituted with an unsubstituted hydrocarbon group.

14. The lithium secondary battery according to claim 3, wherein the compound is a compound in which at least two thiol groups are bonded to the 1,3,5-triazine ring skeleton.
